(19) United States
(12) Patent Application Publication
(10) Pub. No.: US 2016/0063501 A1
(43) Pub. Date: Mar. 3, 2016

(54) SYSTEM FOR DETECTING BANKING FRAUDS BY EXAMPLES

(71) Applicant: Saraansh Software Solutions PVt. Ltd., Bangalore (IN)

(72) Inventors: Malathi Kalyan, Bangalore (IN); Abhi Dattasharma, West Bengal (IN); Rajesh Vasudevan, Bangalore (IN); Santosh V. Yogindrappa, Bangalore (IN)

(21) Appl. No.: 14/936,303

(22) Filed: Nov. 9, 2015

Related U.S. Application Data
(63) Continuation-in-part of application No. 12/404,676, filed on Mar. 16, 2009, now abandoned.

(30) Foreign Application Priority Data
Jun. 18, 2008 (IN) 1060/KOL/08

(51) Int. Cl. G06Q 20/40; G06Q 20/10

(52) U.S. Cl. CPC G06Q 20/4016; G06Q 20/108

(57) ABSTRACT

A computer system for detecting banking frauds in historical data and future transactions from a user supplied specimen set of fraudulent transactions can include: a user console that receives a type of fraud and a plurality of known fraudulent banking transactions associated with the type of fraud from the user; a first set of clue detectors operating on the plurality of known fraudulent banking transactions from the user; a clue detector archive that stores a second set of clue detectors, wherein each of the stored second set of clue detectors has a score that exceeds a threshold value for each clue detector; and a backpropagation neural network that calculates a weight for the stored second set of clue detectors using a learning scheme, wherein a fraud scenario is created based on the stored second set of clue detectors and corresponding weights.

### CROSS REFERENCE TO RELATED APPLICATION

This application is a continuation-in-part application of U.S. application Ser. No. 12/404,676, filed on Mar. 16, 2009, which claims priority to Indian Application No. 1060/KOL/08 filed on Jun. 18, 2008, the contents of which are hereby incorporated by reference herein.

### FIELD OF INVENTION

The present invention relates to a system for detecting banking frauds. More particularly, the present invention relates to a system for analyzing banking transaction data and finding similar fraud examples given one or several user defined specimen frauds.

### PRIOR ART CITATIONS

Document WO 2006/085293, by Paul Kerley et al., discloses a transaction data processing system. U.S. patent application Ser. No. 11/148,472 by Mitchell F Berk et al. provides a runtime thresholds for behavior detection.

U.S. patent application Ser. No. 11/252,696 by Clark R Abrahams et al. provides a systems and methods for analyzing disparate treatment in financial transactions.

U.S. patent application Ser. No. 11/402,287 by Robert Welsh et al, provides an integrated fraud management systems and methods.

U.S. Pat. No. 7,089,592 B2 by Akli Adjaoute provides a systems and methods for dynamic detection and prevention of electronic fraud.

U.S. Pat. No. 7,296,734 B2 by Robert K Pliha provides a systems and methods for scoring bank customers direct deposit account transaction activity to match financial behavior to specific acquisition, performance and risk events defined by the bank using a decision tree and stochastic process.

In the known systems the problem of transaction fraud detection has been looked at from a global perspective. First, historical transactions are analyzed using stochastic, statistical or data mining methods to determine a model and then this model was applied to new transactions in real time. Several existing techniques built the model based on anomaly detection or behavior analysis of user's pattern, and some have used a hybrid technology.

Behavior pattern has been used especially strongly for finding creditworthiness of a customer. However, all of these techniques invariably needed a set of previous transactions spanning over a sufficiently long time as a historical data, this data then acted as the critical part of the model builder. No existing technique works with user feedback to detect transaction fraud. This is, no existing technique can accept only a user specified set of fraudulent transactions and build a model only from that. Thus, learning by examples is not tackled in prior art.

### SUMMARY OF THE INVENTION

The main object of the present invention is to provide a system for detecting banking frauds by mechanizing the discovery of similar instances of fraud with machine learning techniques.

This invention deals with an innovative system to detect frauds in banking transactions based on examples shown by user. The user points out a set of transactions in a transaction database as a specimen fraud. The system now analyzes this set of transactions, determines the important parameters of the transactions and assigns a set of clue detectors and their relative weights to define a “scenario” for this set. Once done, this scenario is then applied over the entire database of transactions to find all instances of similar frauds. This enables the user to find out hitherto unknown or missed fraudulent cases and help to audit the transactions properly. Human ingenuity can find the first instance of new frauds.

However, mechanizing the discovery of the similar instances is best done with machine learning techniques based on pattern recognition ideas.

In a preferred embodiment of the present invention it provides a system for detecting banking frauds in historical data and future transactions from a user supplied specimen set of fraudulent transactions, the specimen set of transactions defining one type of fraud identified by the user, the system comprises: means to accept at least one set of banking transactions from the user and means to accept a type of fraud associated with each the set of transactions from the user; means to run a set of atomic clue detectors on each the transaction for each the specimen; means to store the output of the clue detectors for each the transactions for each the specimen fraudulent transactions; means to compare the output of each the clue detector with a pre-defined threshold; means to assign weight to each the clue detector; means to combine the clue detectors and their the weights into one fraud scenario; and means to apply the fraud scenario on an archive of transactions or online transactions for detecting possible fraud of the the type.

A computer system for detecting banking frauds in historical data and future transactions from a user supplied specimen set of fraudulent transactions, where the specimen set of transactions can define one type of fraud identified by the user, can include: a user console that receives a type of fraud and a plurality of known fraudulent banking transactions associated with the type of fraud from the user; a first set of clue detectors operating on the plurality of known fraudulent banking transactions from the user, wherein each of the first set of clue detectors determines a score for each transaction in the plurality of known fraudulent banking transactions, wherein the first set of clue detectors compares the transaction to a set of clues and adjusts the score based on a match; a clue detector archive that stores a second set of clue detectors, wherein each of the stored second set of clue detectors has a score that exceeds a threshold value for each clue detector; and a backpropagation neural network that calculates a weight for the stored second set of clue detectors using a learning scheme, wherein a fraud scenario is created based on the stored second set of clue detectors and corresponding weights, wherein the fraud scenario is applied on an archive of transactions or online transactions for detecting the fraud scenario, and wherein the calculated weight is assigned for each of the stored second set of clue detectors following a monotone function of their outputs.

A computer system for detecting a plurality of banking frauds associated with a plurality of transactions can include: a user console that accepts a type of fraud and a plurality of example fraudulent transactions associated with the type of fraud from a single account or a plurality of accounts; a plurality of clue detectors comprising a burst detector, an outlier detector, and an anomaly detector, wherein the plurality of clue detectors are set up using a plurality of parameters, wherein a parameter of the plurality of parameters is associated with an example transaction of the plurality of example transactions or an account of the plurality of accounts, wherein the plurality of clue detectors are reconfigurable based on the fraud scenario, wherein each of the plurality of clue detectors determines a score for each of the example fraudulent transactions associated with the type of fraud; a filter that builds a fraud scenario based on the plurality of parameters derived from the example fraudulent transactions associated with the type of fraud; and a neural network that determines a plurality of weights associated with the plurality of clue detectors based on the output of the plurality of clue detectors with respect to the plurality of example transactions, wherein the determined plurality of weights are assigned for each of the plurality of clue detectors following a monotone function of their outputs.

A computer-implemented method for detecting a plurality of banking frauds associated with a plurality of transactions, can include: receiving, by a computer system, a plurality of known fraudulent transactions from a single account or a plurality of accounts; analyzing, by the computer system, context and patterns hidden in the plurality of known fraudulent transactions to extract parameters; running, by the computer system, the plurality of known fraudulent transactions against a plurality of atomic clue detectors based on the extracted parameters, wherein the atomic clue detectors return a score; retaining, by the computer system, a subset of atomic clue detectors from the plurality of atomic clue detectors based on the score, wherein the score for each atomic clue detector in the subset of atomic clue detectors is above a threshold value; assigning, by the computer system, a weight to each atomic clue detector in the subset of atomic clue detectors, wherein the weight is calculated by a learning scheme using a backpropagation neural network; creating, by the computer system, a fraud scenario based on the extracted parameters and clue detectors; receiving, by the computer system, a second set of transactions for detecting the fraud scenario; and detecting, by the computer system, the fraud scenario on the second set of transactions based on the clue detectors, wherein the calculated weight is assigned for each of the retained subset of atomic clue detectors following a monotone function of their outputs.

### BRIEF DESCRIPTION OF THE ACCOMPANYING DRAWINGS

The invention can now be described in detail with the help of the figures of the accompanying drawings in which FIG. 1 is a block diagram of the system.

FIG. 2 is a block diagram showing a scenario and the clue detectors.

FIG. 3 is a flow diagram of the system where important parameters of an example fraud are extracted.

FIG. 4 is a flow diagram of the system where the determined set of parameters is used to find similar instances of fraud.

FIG. 5 is a diagram of the system for detecting banking frauds from user specified examples.

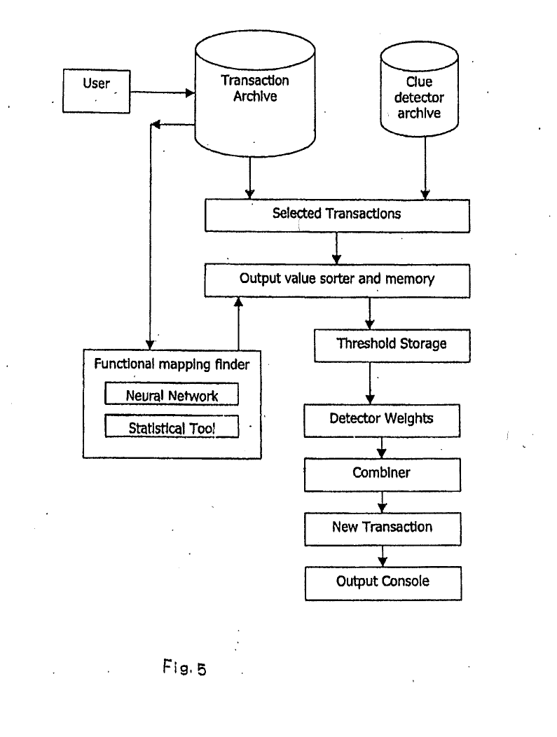

FIG. 6 is a diagram showing illustrative elements of a computer system.

FIG. 7 is a diagram showing illustrative elements of a computer system.

### DETAILED DESCRIPTION

In banking industry, chances of fraud taking place during a transaction are an omnipresent threat, and this can be quite serious in nature. This can not only harm a customer, but can damage a bank's reputation seriously.

Therefore, it is necessary for a bank to have a fraud detection system in place.

Unfortunately, having a fraud detection system is not enough. Usually, any electronic system for fraud detection is not perfect, and fails to recognize certain frauds, especially the new and clever ones. Rectifying the software continuously to take into account such novel cases can be time and money wasting, and a bank cannot always afford to have that.

The present invention is a system that tackles the problem in a different way. In this system, the user simply points out a set of transactions which comprises a fraudulent case. The user is permitted to show more than one such case. That is, human intelligence is used by the system to tell it what may be a fraud. The system then picks up the transactions and analyzes the context and patterns hidden in those transactions. In the process, it extracts those parameters which seem to be most important for this particular case, and it creates a fraud scenario on its own. The parameters and their relative importance are then set up as a clue detector combination, which can then be used on any transaction to detect similar frauds.

A novel aspect of this invention is the following. All the existing techniques for detection of fraud provide a pre-defined set of clue detectors and a set of scenarios, and any transaction is mapped to this existing set. An intuitive outline is as follows:

Item 1: Build a set of atomic clue detectors, each one capable of defining one particular pre-defined transaction clue. For example, whether the debit value is more than the user's most commonly used debit values can be an atomic clue detector. A sample set of atomic clues are given below:
Credit pattern of the user
Debit pattern of the user
Usual transaction time of the user
User transaction channel of user
Usual transaction place of the user
If the transaction contains too low values
If user's account was dormant
If the user requested a change of address
If the transaction contains sharp bursts

Item 2: Build a set of fraud scenarios, each scenario is a depiction of a particular pre-defined fraud pattern. For example, a sudden burst of unusually high debits on successive days can be one fraud scenario.

Item 3: For each such scenario, define a set of clue detectors with their relative weights such that the clue detectors send back a heavy score when that fraud scenario occurs. For example, the scenario as above can use the clue detector “Debit pattern” of item 1 with high weight.

Item 4: For every new transaction, run each of these fraud scenarios, and report a fraud if the score is sufficiently high.

In embodiments of the present invention, the above list is augmented with a very powerful new item:

Item 5: For any fraud instance found by a human moderator, ask the system to automatically build a fraud scenario depicting this fraud, and automatically set up clue detectors so that such frauds can now be automatically found.

The fraud detection will now be described by examples system in steps.

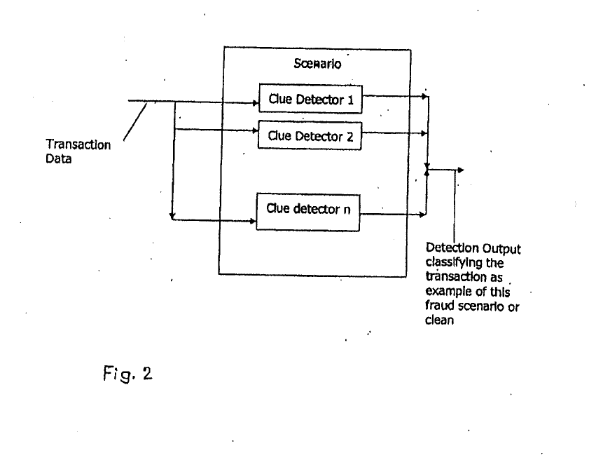

The first steps of the process are illustrated in FIG. 3. These are described below.

Step 0: First, the user marks a set of transactions as one instance of a fraud. If possible, the user marks several such sets as multiple examples.

Step 1: For every one of those transactions, all the atomic clue detectors are run.

Step 2: The output of each clue detector is taken, and the values are sorted.

Step 3: The clue detectors which return values greater than pre-defined threshold are retained for the final set.

Steps 4 and 5: A set of weight for the clue detectors are found using a functional mapping. The set of clue detectors which return values greater than pre-defined threshold for every specimen of fraud are given the highest weight; other clue detectors which were retained are given lower weight. The weight monotonically increases as the clue detectors' outputs increase. When the user gives a sufficiently large set of examples, the mapping is found using a learning scheme, namely, a backpropagation neural network.

Step 6: A combination of the final parameters or retained clue detectors is stored as a scenario for detecting the particular example fraud.

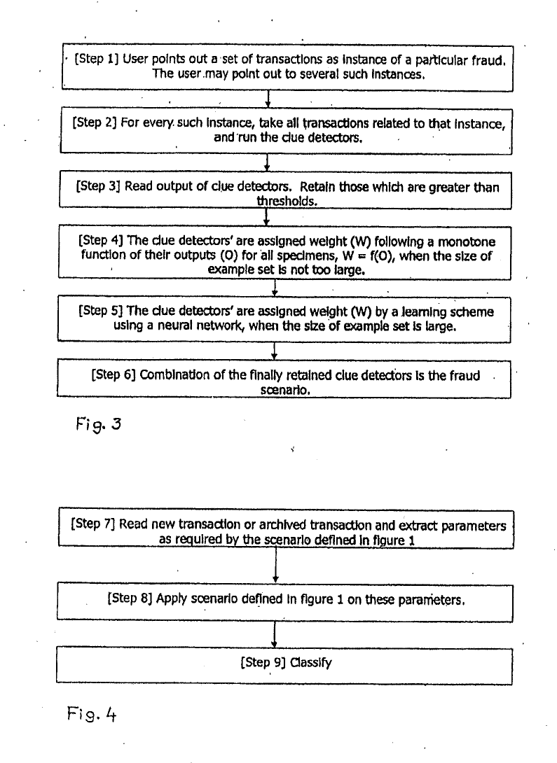

The aforementioned scenario is now used for detecting any suspicious outgoing e-mail. The steps are as follows, shown in FIG. 4.

Step 7: For every new transaction, said set of parameters as obtained in step 5 are extracted.

Step 8: The scenario as obtained in step 5 are run on this set of parameters.

Step 9: Depending on the score, a classification is given to the transaction if the said output crosses a pre-defined threshold or fails below a pre-defined threshold, respectively.

In the present invention for determination of the outputs of the atomic clue detectors for each said specimen fraudulent case, the system comprises: means for accepting a list of atomic clue detectors (FIG. 3, step 2); means for accepting the set of transactions for every said specimen fraudulent case (FIG. 3 step 1); means for running every atomic clue detector on each said transaction (FIG. 3 step 2); and means for storing the output of each said atomic clue detector on each said transaction of each said specimen fraudulent case (FIG. 3 step 3).

For determination of the outputs of the system a set of clue detectors for the final scenario, comprises: means for accepting a set of threshold values for the aforementioned set of atomic clue detectors (FIG. 3, step 3); means for comparing the output of each of said atomic clue detectors to the threshold for the corresponding atomic clue detector (FIG. 3 step 3); and means for retaining those clue detectors for which the output exceeds the said threshold.

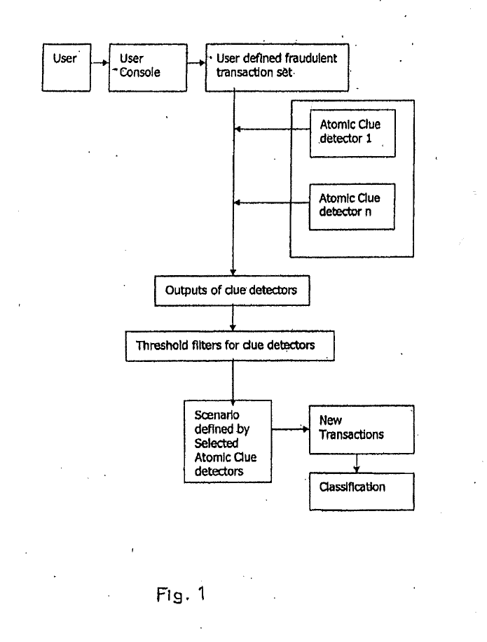

For determining a set of weights for the set of clue detectors, the system can comprise: means for designing a functional mapping f, said functional mapping accepting the output values of the clue detectors for all specimen fraudulent cases as inputs and returning a real value as output (FIG. 2 step 4); means for designing a neural network based learning scheme to generate a functional mapping f, the said functional mapping accepting the output values of the clue detectors for all specimen fraudulent cases as inputs and returning a real value as output; means for supplying the outputs of said clue detectors to said function (FIG. 3 steps 4 and 5); and means for storing the outputs of said function as weights corresponding to said clue detectors.

In the present invention a combination of the final parameters from the clue detectors can be stored for detecting a fraud scenario. For using said fraud scenario to detect frauds similar to the specimen fraud shown by the user from archived data or from new transactions, the system can further comprise: means for scanning old transactions from archived transaction data (FIG. 4 step 7); means for scanning new transactions (FIG. 4 step 7); means for applying said fraud scenario on archived transaction data (FIG. 4, step 8); means for applying the aforementioned fraud scenario on new transaction data (step 8); and means for classifying a set of transactions as fraud depending on a score obtained by application of the said fraud scenario [step 9].

A computer system for detecting banking frauds in historical data and future transactions from a user-supplied specimen set of fraudulent transactions that define one type of fraud identified by the user, can include: a user console that receives a type of fraud and a plurality of known fraudulent banking transactions associated with the type of fraud from the user. The user console can include at least one data processor.

The system can further include a first set of clue detectors operating on the plurality of known fraudulent banking transactions from the user. Each of the first set of clue detectors can determine a score for each transaction in the plurality of known fraudulent banking transactions. The first set of clue detectors can compare the transaction to a set of clues and can adjust the score based on a match.

The system can include a clue detector archive that stores a second set of clue detectors. Each of the stored second set of clue detectors can have a score that exceeds a threshold value for each clue detector. The clue detector archive can comprise at least one of: a credit pattern of the user, a debit pattern of the user, a usual transaction time of the user, a user transaction channel of the user, a usual transaction place of the user, whether a transaction contains values below a predetermined threshold, whether the user's account has been dormant, whether the user has requested a change of address, and whether the transaction comprises sharp bursts.

The system can include a backpropagation neural network that calculates a weight for the stored second set of clue detectors using a learning scheme. A fraud scenario can be created based on the stored second set of clue detectors and corresponding weights. The fraud scenario can be applied on an archive of transactions or online transactions for detecting the fraud scenario. The calculated weight can be assigned for each of the stored second set of clue detectors following a monotone function of their outputs.

The system can further include a second user console that receives a list of atomic clue detectors and the plurality of known fraudulent banking transactions. Every atomic clue detector can be run on each said transaction. The system can also further include a second archive that stores the output of each said atomic clue detector on each said transaction of each said specimen.

The system can further include a second user console configured to accept a plurality of threshold values. The second user console can include at least one data processor.

In some embodiments, the backpropagation neural network can include the learning scheme to generate a functional mapping f. The functional mapping can accept the output values of the clue detectors for all fraudulent banking transactions as inputs and returning a real value as output. A third archive can store the outputs of the function as weights corresponding to the clue detectors. The fraud scenario can comprise a combination of remaining clue detectors.

The system can further comprise a transaction scanner that scans old transactions from archived transaction data and that scans new transactions. The fraud scenario can be applied on archived transaction data and the fraud scenario can be applied on new transaction data. A set of transactions can be classified as fraud depending on a score obtained by application of the fraud scenario.

A computer system for detecting a plurality of banking frauds associated with a plurality of transactions can include a user console that accepts a type of fraud and a plurality of example fraudulent transactions associated with the type of fraud from a single account or a plurality of accounts. The user console can include at least one data processor.

The system can include a plurality of clue detectors comprising a burst detector, an outlier detector, and an anomaly detector. The plurality of clue detectors can be set up using a plurality of parameters. A parameter of said plurality of parameters can be associated with an example transaction of said plurality of example transactions or an account of the plurality of accounts. The plurality of clue detectors can be reconfigurable based on the fraud scenario. Each of the plurality of clue detectors can determine a score for each of the example fraudulent transactions associated with the type of fraud.

The system can include a filter that builds a fraud scenario based on the plurality of parameters derived from the example fraudulent transactions associated with the type of fraud. The system can include a neural network that determines a plurality of weights associated with the plurality of clue detectors based on the output of the plurality of clue detectors with respect to the plurality of example transactions. The determined plurality of weights can be assigned for each of the plurality of clue detectors following a monotone function of their outputs.

A computer-implemented method for detecting a plurality of banking frauds associated with a plurality of transactions, can include receiving, by a computer system, a plurality of known fraudulent transactions from a single account or a plurality of accounts.

The method can include analyzing, by the computer system, context and patterns hidden in the plurality of known fraudulent transactions to extract parameters. The method can include running, by the computer system, the plurality of known fraudulent transactions against a plurality of atomic clue detectors based on the extracted parameters. The atomic clue detectors can return a score.

The method can include retaining, by the computer system, a subset of atomic clue detectors from the plurality of atomic clue detectors based on the score. The score for each atomic clue detector in the subset of atomic clue detectors can be above a threshold value.

The method can include assigning, by the computer system, a weight to each atomic clue detector in the subset of atomic clue detectors. The weight can be calculated by a learning scheme using a backpropagation neural network.

The method can include creating, by the computer system, a fraud scenario based on the extracted parameters and clue detectors; receiving, by the computer system, a second set of transactions for detecting the fraud scenario; and detecting, by the computer system, the fraud scenario on the second set of transactions based on the clue detectors. The calculated weight can be assigned for each of the retained subset of atomic clue detectors following a monotone function of their outputs.

### Examples

The following describes a fraud scenario which is input by a user as a “Fraud By Example.” A narrative of fraud scenario can be explained with transaction labels in the first section. A narrative of the working of fraud detection is given in a separate section. Results of fraud detection are described in subsequent sections. Tables are provided to show the temporal description of fraud scenario with score outputs for individual transactions.

Narrative of Events

A description of the sequence of transactions done by John is given below, as shown in Table 1. Each event is given a label.

At the first event, T1, John does an internet transaction in Mumbai (a city on the western coast of India) for buying an air ticket at 10:35 AM on 21st February. This is a high value transaction of 100K rupees (Indian currency) approximately.

At the second event, T2, John uses an ATM to withdraw money in Delhi (a city which is 2 and a half hours by flight from Mumbai) at 10:37 AM on 21st February (i.e., 2 minutes later). John does another high value transaction of 45K approximately.

At the third event, T3, John does another high value transaction of approximately 55 k in Bangalore (1 hour by flight from Mumbai) at 10:39 AM that same day at a POS of a suspicious merchant.

Narrative of Detection Technology
Inter Transaction Gap for High Value transactions (ITG) is a clue detector that can be used by the system. If an inter transaction gap for high value transactions is far less than what is normal with the entity, the clue detector is fired.
The system can use two Clue Detectors (CDs) including amount of Usage (AOU) and Time of Usage (TOU) for checking the anomaly of amount and time of usage with respect to normal behavior of entity.
Geo location velocity is checked with another CD (Vel-Loc) across a set of transactions.

Narrative of Results of Detection

The third transaction, labeled T3 in the example set, raises alerts. The same is depicted in a tabular fashion below in Table 1.

Usage of Artificial Neural Network (ANN) and sets of Clue Detectors.

The first set of Clue detectors can be compared with thresholds as shown in Table 2 to check if individual transactions have crossed the thresholds. If so, scores are adjusted based on the gap between threshold and actual value.

The second set of clue detectors comprises those clue detectors of set 1 which have crossed thresholds, as shown in Table 3.

Fraud by Example:
ANN is trained with the given example as a fraud.
The given example is given as a fraud by example to software.
ANN gets the transactions along with user feedback that the given set constitutes a fraud.

Weight adjusting ANN for learning:
The given input sequence is a known fraud.
Relative weights of clue detectors will be adjusted to create a fraud scenario for the above combination.

The term “computer” is intended to have a broad meaning that may be used in computing devices such as, e.g., but not limited to, standalone or client or server devices. The computer may be, e.g., (but not limited to) a personal computer (PC) system running an operating system such as, e.g., (but not limited to) MICROSOFT® WINDOWS® NT/98/2000/XP/Vista/Windows 7/8/8.1/10 etc. available from MICROSOFT® Corporation of Redmond, Wash., U.S.A. or an Apple computer executing MAC® OS from Apple® of Cupertino, Calif., U.S.A. Computer configurations running other operating systems such as Linux and ChromeOS are also contemplated within the scope of the invention. However, the invention is not limited to these platforms. Instead, the invention may be implemented on any appropriate computer system running any appropriate operating system. Further, the invention may be implemented on a cloud computing unit and mobile devices. In one embodiment, the invention may be a cloud-based SaaS platform and able to be accessed on computers, tablets, iPads, smartphones, etc.

In one illustrative embodiment, the present invention may be implemented on a computer system operating as discussed herein. The computer system may include, e.g., but is not limited to, a main memory, random access memory (RAM), and a secondary memory, etc. Main memory, random access memory (RAM), and a secondary memory, etc., may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, etc.

The secondary memory may include, for example, (but is not limited to) a hard disk drive and/or a removable storage drive, representing a floppy diskette drive, a magnetic tape drive, an optical disk drive, a compact disk drive CD-ROM, flash memory, cloud instance, etc. The removable storage drive may, e.g., but is not limited to, read from and/or write to a removable storage unit in a well-known manner. The removable storage unit, also called a program storage device or a computer program product, may represent, e.g., but is not limited to, a floppy disk, magnetic tape, optical disk, compact disk, etc. which may be read from and written to the removable storage drive. As will be appreciated, the removable storage unit may include a computer usable storage medium having stored therein computer software and/or data.

In alternative illustrative embodiments, the secondary memory may include other similar devices for allowing computer programs or other instructions to be loaded into the computer system. Such devices may include, for example, a removable storage unit and an interface. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM)) and associated socket, and other removable storage units and interfaces, which may allow software and data to be transferred from the removable storage unit to the computer system.

The computer may also include an input device including any mechanism or combination of mechanisms that may permit information to be input into the computer system from, e.g., a user. The input device may include logic configured to receive information for the computer system from, e.g. a user. Examples of the input device may include, e.g., but are not limited to include, a mouse, pen-based pointing device, or other pointing device such as a digitizer, a touch sensitive display device, and/or a keyboard or other data entry device (none of which are labeled). Other input devices may include, e.g., but are not limited to include, a biometric input device, a video source, an audio source, a microphone, a web cam, a video camera, and/or other camera. The input device may communicate with a processor either wired or wirelessly.

The computer may also include output devices which may include any mechanism or combination of mechanisms that may output information from a computer system. An output device may include logic configured to output information from the computer system. Embodiments of an output device may include, e.g., but are not limited to include, display, and display interface, including displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc. The computer may include input/output (I/O) devices such as, e.g., (but not limited to) communications interface, cable and communications path, etc. These devices may include, e.g., but are not limited to, a network interface card, and/or modems. The output device may communicate with processor either wired or wirelessly. A communications interface may allow software and data to be transferred between the computer system and external devices.

The term “data processor” is intended to have a broad meaning that includes, e.g., but is not limited to include, one or more central processing units that are connected to a communication infrastructure (e.g., but not limited to, a communications bus, cross-over bar, interconnect, or network, etc.). The term data processor may include any type of processor, microprocessor and/or processing logic that May interpret and execute instructions (e.g., for example, a field programmable gate array (FPGA)). The data processor may comprise a single device (e.g., for example, a single core) and/or a group of devices (e.g., multi-core). The data processor may include logic configured to execute computer-executable instructions configured to implement one or more embodiments. The instructions may reside in main memory or secondary memory. The data processor may also include multiple independent cores, such as a dual-core processor or a multi-core processor. The data processors may also include one or more graphics processing units (GPU) which may be in the form of a dedicated graphics card, an integrated graphics solution, and/or a hybrid graphics solution. Various illustrative software embodiments may be described in terms of this illustrative computer system. After reading this description, it will become apparent to a person skilled in the relevant art(s) how to implement the invention using other computer systems and/or architectures.

The term “data storage device” is intended to have a broad meaning that includes removable storage drive, a hard disk installed in hard disk drive, flash memories, removable discs, non-removable discs, Cloud storage such as Amazon, Apple, Dell, Google, etc., and other storage implementations. In addition, it should be noted that various electromagnetic radiation, such as wireless communication, electrical communication carried over an electrically conductive wire (e.g., but not limited to twisted pair, CATS, etc.) or an optical medium (e.g., but not limited to, optical fiber) and the like may be encoded to carry computer-executable instructions and/or computer data that embodiments of the invention on e.g., a communication network. These computer program products may provide software to the computer system. It should be noted that a computer-readable medium that comprises computer-executable instructions for execution in a processor may be configured to store various embodiments of the present invention.

### Illustrative Computing Architecture Example System

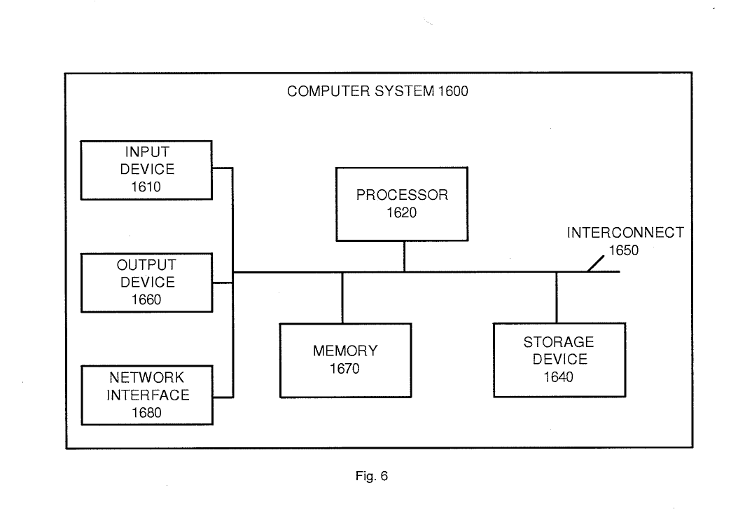

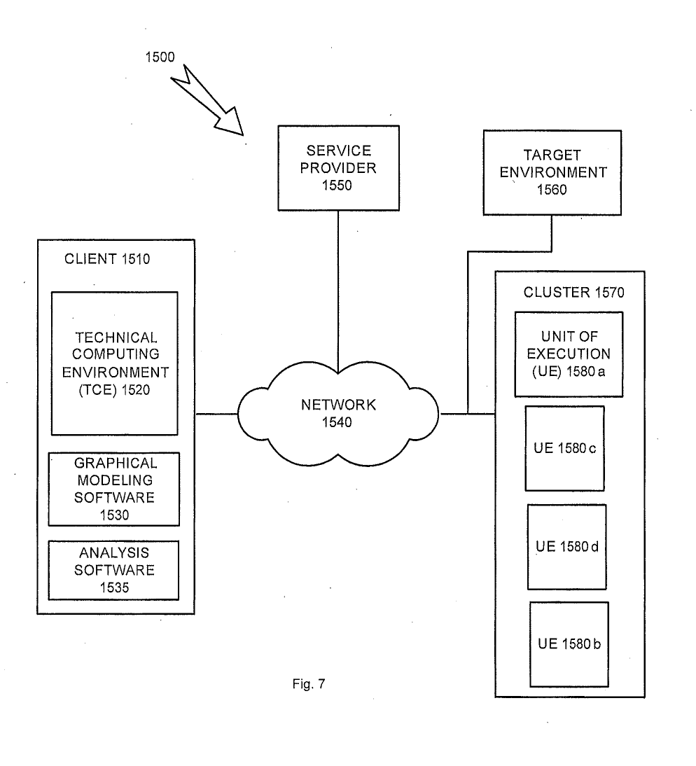

FIGS. 6 and 7 illustrate an example of a computer system 1600 that may be configured to practice an embodiment of the invention. For example, computer system 1600 may be used to implement client 1510, service provider 1550, target environment 1560, programming environment 100, etc. Computer system 1600 may include processor 1620, memory 1670, storage device 1640, input device 1610, output device 1660, and network interface 1680. Processor 1620 may include logic configured to execute computer-executable instructions that implement embodiments of the invention. An example of a processor that may be used with the invention includes the Pentium® processor, Core i7® processor, or Xeon® processor all available from Intel Corporation, Santa Clara, Calif. The instructions may reside in memory 1670 and may include instructions associated with TCE 1520.

Memory 1670 may be a computer-readable medium that may be configured to store instructions configured to implement embodiments of the invention. Memory 1670 may be a primary storage accessible to processor 1620 and can include a random-access memory (RAM) that may include RAM devices, such as, for example, Dynamic RAM (DRAM) devices, flash memory devices, Static RANI (SRAM) devices, etc. Storage device 1640 may include a magnetic disk and/or optical disk and its corresponding drive for storing information and/or instructions. Memory 1670 and/or storage device 1640 may store class definitions 1405-1475.

Interconnect 1650 may include logic that operatively couples components of computer system 1600 together. For example, interconnect 1650 may allow components to communicate with each other, may provide power to components of computer system 1600, etc. In an embodiment of computer system 1600, interconnect 1650 may be implemented as a bus.

Input device 1610 may include logic configured to receive information for computer system 1600 from, e.g., a user. Embodiments of input device 1610 may include keyboards, touch sensitive displays, biometric sensing devices, computer mice, trackballs, pen-based point devices, etc. Output device 1660 may include logic configured to output information from computer system. Embodiments of output device 1660 may include cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc.

Network interface 1680 may include logic configured to interface computer system 1600 with a network, e.g., network 1540, and may enable computer system 1600 to exchange information with other entities connected to the network, such as, for example, service provider 1550, target environment 1560 and cluster 1570. Network interface 1680 may be implemented as a built-in network adapter, network interface card (NIC), Personal Computer Memory Card International Association (PCMCIA) network card, card bus network adapter, wireless network adapter, Universal Serial Bus (USB) network adapter, modem or any other device suitable for interfacing computer system 1600 to any type of network.

It should be noted that embodiments may be implemented using some combination of hardware and/or software. It should be further noted that a computer-readable medium that includes computer-executable instructions for execution in a processor may be configured to store embodiments of the invention. The computer-readable medium may include volatile memories, non-volatile memories, flash memories, removable discs, non-removable discs and so on. In addition, it should be noted that various electromagnetic signals such as wireless signals, electrical signals carried over a wire, optical signals carried over optical fiber and the like may be encoded to carry computer-executable instructions and/or computer data on e.g., a communication network for an embodiment of the invention.

A hardware unit of execution may include a device (e.g., a hardware resource) that performs and/or participates in parallel programming activities. For example, a hardware unit of execution may perform and/or participate in parallel programming activities in response to a request and/or a task it has received (e.g., received directly or via a proxy). A hardware unit of execution may perform and/or participate in substantially any type of parallel programming (e.g., task, data, stream processing, etc.) using one or more devices. For example, in one implementation, a hardware unit of execution may include a single processing device that includes multiple cores, and in another implementation, the hardware unit of execution may include a number of processors 1620. A hardware unit of execution may also be a programmable device, such as a field programmable gate array (FPGA), an application specific integrated circuit (ASIC), a digital signal processor (DSP), etc. Devices used in a hardware unit of execution may be arranged in substantially any configuration (or topology), such as a grid, ring, star, etc. A hardware unit of execution may support one or more threads (or processes) when performing processing operations.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

TABLE 1
Tabular Description of Transactions in Fraud by Example case

| | | | | | | | | | Product |
|---|---|---|---|---|---|---|---|---|---|
| | | | | | | | | | & |
| Party | Node | | | | | | Merchant | | Channel |
| Identification | Address | Date | Time | Amount | Credit/Debit | Location | ID | MCC | Code |
| Xxxx | Ip | Feb. 21, 2008 | 10:35 | 10000.23 | Debit | Mumbai | | Travel | Internet, |
| 1234 | address | | | | | | | | Online |
| yyyy | used is | | | | | | | | Purchase |
| 5678 | new | | | | | | | | |
| Xxxx | ATM | Feb. 21, 2008 | 10:37 | 45867.45 | Debit | Delhi | | | ATM |
| 1234 | Node | | | | | | | | Cash |
| yyyy | | | | | | | | | |
| 5678 | | | | | | | | | |
| Xxxx | Ip | Feb. 21, 2008 | 10:39 | 55000.67 | Debit | Bangalore | Suspicious | Gold | POS |
| 1234 | address | | | | | | Merchant | | |
| yyyy | of POS of | | | | | | | | |
| 5678 | merchant | | | | | | | | |

TABLE 2
First Set of Clue Detectors

| | | | | | Identifi- |
|---|---|---|---|---|---|
| | | | | | cation of |
| Clue | | Reasoning | | Thresh- | trans- |
| Detector | Field 1 | logic of CD | Score | old | actions |
| TOU | Time & Date | Anomaly of time | 450 | 650 | T1 T2 T3 |
| | | and day of week | | | |
| | | (in office hours | | | |
| | | and on weekdays) | | | |
| AOU | Amount | Weekly | 500 | 700 | T1 |
| | | cumulative | 600 | 700 | T2 |
| | | amount burst, | 900 | 700 | T3 |
| | | Daily cumulative | | | |
| | | amount burst | | | |
| Inter | Measure | Is this a channel | 500 | 850 | T1 |
| Trans- | inter | on which he | 700 | 850 | T2 |
| action | transaction | normally does | 1000 | 850 | T3 |
| Gap and | gap for high | transactions of | | | |
| Channel | amount | this value | | | |
| usage | transactions. | | | | |
| (ITG) | | | | | |
| Location | Inter | Is this feasible | 500 | 700 | T1 |
| usage or | location gap | and normal for | 1000 | 700 | T2 T3 |
| Velocity | divided by | this entity? | | | |
| | Inter | | | | |
| (Vel_loc) | transaction | | | | |
| | gap | | | | |

TABLE 3
Second set of clue detectors

| | Transactions Satisfying | |
|---|---|---|
| CD Label | in latest test | Scores |
| AOU | T3 | 900 |
| ITG | T3 | 1000 |
| Vel_loc | T2 | 1000 |
| | T3 | 1000 |

What is claimed is:

1. A computer system for detecting banking frauds in historical data and future transactions from a user supplied specimen set of fraudulent transactions, said specimen set of transactions defining one type of fraud identified by the user, said system comprises:
a user console that receives a type of fraud and a plurality of known fraudulent banking transactions associated with the type of fraud from the user;
a first set of clue detectors operating on the plurality of known fraudulent banking transactions from the user, wherein each of the first set of clue detectors determines a score for each transaction in the plurality of known fraudulent banking transactions, wherein the first set of clue detectors compares the transaction to a set of clues and adjusts the score based on a match;
a clue detector archive that stores a second set of clue detectors, wherein each of the stored second set of clue detectors has a score that exceeds a threshold value for each clue detector; and
a backpropagation neural network that calculates a weight for the stored second set of clue detectors using a learning scheme, wherein a fraud scenario is created based on the stored second set of clue detectors and corresponding weights,
wherein said fraud scenario is applied on an archive of transactions or online transactions for detecting the fraud scenario, and
wherein said calculated weight is assigned for each of the stored second set of clue detectors following a monotone function of their outputs.

2. The system according to claim 1, further comprising:
a second user console that receives a list of atomic clue detectors and the plurality of known fraudulent banking transactions, wherein every atomic clue detector is run on each said transaction; and
a second archive that stores the output of each said atomic clue detector on each said transaction of each said specimen.

3. The system according to claim 1, further comprising:
a second user console configured to accept a plurality of threshold values.

4. The system according to claim 1, wherein the backpropagation neural network comprises the learning scheme to generate a functional mapping f, the said functional mapping accepting the output values of the clue detectors for all fraudulent banking transactions as inputs and returning a real value as output, wherein;
a third archive that stores the outputs of the function as weights corresponding to the clue detectors.

5. The system according to claim 1, wherein the fraud scenario comprises a combination of remaining clue detectors.

6. The system according to claim 1, further comprising:
a transaction scanner that scans old transactions from archived transaction data and that scans new transactions, wherein the fraud scenario is applied on archived transaction data and the fraud scenario is applied on new transaction data, and wherein a set of transactions is classified as fraud depending on a score obtained by application of the fraud scenario.

7. A computer system for detecting a plurality of banking frauds associated with a plurality of transactions, the system comprising:
a user console that accepts a type of fraud and a plurality of example fraudulent transactions associated with the type of fraud from a single account or a plurality of accounts;
a plurality of clue detectors comprising a burst detector, an outlier detector, and an anomaly detector, wherein the plurality of clue detectors are set up using a plurality of parameters, wherein a parameter of said plurality of parameters is associated with an example transaction of said plurality of example transactions or an account of said plurality of accounts, wherein the plurality of clue detectors are reconfigurable based on the fraud scenario, wherein each of the plurality of clue detectors determines a score for each of the example fraudulent transactions associated with the type of fraud;
a filter that builds a fraud scenario based on the plurality of parameters derived from the example fraudulent transactions associated with the type of fraud; and
a neural network that determines a plurality of weights associated with the plurality of clue detectors based on the output of the plurality of clue detectors with respect to the plurality of example transactions,
wherein said determined plurality of weights are assigned for each of the plurality of clue detectors following a monotone function of their outputs.

8. A computer-implemented method for detecting a plurality of banking frauds associated with a plurality of transactions, the method comprising:
receiving, by a computer system, a plurality of known fraudulent transactions from a single account or a plurality of accounts;
analyzing, by the computer system, context and patterns hidden in the plurality of known fraudulent transactions to extract parameters;
running, by the computer system, the plurality of known fraudulent transactions against a plurality of atomic clue detectors based on the extracted parameters, wherein the atomic clue detectors return a score;
retaining, by the computer system, a subset of atomic clue detectors from the plurality of atomic clue detectors based on the score, wherein the score for each atomic clue detector in the subset of atomic clue detectors is above a threshold value;
assigning, by the computer system, a weight to each atomic clue detector in the subset of atomic clue detectors, wherein the weight is calculated by a learning scheme using a backpropagation neural network;
creating, by the computer system, a fraud scenario based on the extracted parameters and clue detectors;
receiving, by the computer system, a second set of transactions for detecting the fraud scenario; and
detecting, by the computer system, the fraud scenario on the second set of transactions based on the clue detectors,
wherein said calculated weight is assigned for each of the retained subset of atomic clue detectors following a monotone function of their outputs.

9. The system of claim 1, wherein the clue detector archive comprises at least one of: a credit pattern of the user, a debit pattern of the user, a usual transaction time of the user, a user transaction channel of the user, a usual transaction place of the user, whether a transaction contains values below a predetermined threshold, whether the user's account has been dormant, whether the user has requested a change of address, and whether the transaction comprises sharp bursts.
